(19) United States
(12) Patent Application Publication
(10) Pub. No.: US 2025/0291476 A1
(43) Pub. Date: Sep. 18, 2025

(54) METHOD FOR TEXT INPUT USING DIGIT OF HUMAN HAND

(71) Applicant: MING-YING WU, New Taipei City (TW)

(72) Inventor: MING-YING WU, New Taipei City (TW)

(21) Appl. No.: 19/224,879

(22) Filed: Jun. 1, 2025

Related U.S. Application Data
(63) Continuation-in-part of application No. 18/525,838, filed on Nov. 30, 2023.

(51) Int. Cl. G06F 3/04886; G06F 3/041

(52) U.S. Cl. CPC G06F 3/04886; G06F 3/0416

(57) ABSTRACT

A method for text input using a preset digit of a human hand includes steps of placing the human hand in an initial location before sensing, recognizing a first original position and a second original position of the preset digit via a sensor, sensing a first feature via sensing a first part of the preset digit of the human hand, sensing a second feature via a second part of the preset digit of the human hand, combining the sensed first feature with the sensed second feature to create an input unit via a processor, associating characters to be input with first and second features to be sensed, comparing the input unit with the first and second features to be sensed associated with the characters to be input to retrieve a character intended to be input, and repeating the above steps until a text to be input is completely input.

### CROSS REFERENCE TO RELATED APPLICATIONS

The present application is a continuation-in-part application of U.S. patent application Ser. No. 18/525,838, filed on Nov. 30, 2023, the disclosure of which is incorporated by reference herein.

### BACKGROUND OF THE INVENTION

### Field of the Invention

The present invention relates to a method for text input using at least a digit of a human hand. Particularly, a method for text input includes sensing at least one digit movement of the at least a digit of the human hand in order to achieve text input on a display via processing of a processor.

### Description of Related Art

Traditionally, texts are usually input via keyboards equipped within electronic devices. The keyboards are either physically disposed on the electronic devices, and/or virtually displayed on screens of the electronic devices. When a text intended to be input is about to be input, a user has to choose corresponding keys from the keyboards in order to input the text intended to be input in the electronic devices. In other words, the user has to be familiar with a layout of the keyboards which is usually fixed after manufacture of the electronic devices in order to efficiently input the text intended to be input. Hence, the user must firstly find out the corresponding keys from the keyboards and then move his/her fingers toward locations of the corresponding keys to press the corresponding keys based on an order decided by the text intended to be input. Apparently, not only the user had better memorize locations of all keys on the layout of the keyboards, but also his/her fingers have to be moved toward the corresponding keys to press them for text input. Therefore, it is very common for the user to adopt both of his/her hands and fingers with both hands to be ready for the entire layout of the keyboards in order to speed up the text input when the user is about to input the text intended to be input. Text input using a single hand, particularly using a digit of the single hand, of the user is well known to be more time-consuming than using two hands with multiple digits of the user.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic flowchart diagram of a method for text input using at least a digit of a human hand in accordance with a preferred embodiment of the present invention.

FIG. 2 shows a schematic side view of a preferred digit of a human hand presenting an original primary feature and other preset primary features of the preferred digit of the human hand for the method for text input using at least a digit of a human hand of FIG. 1 in accordance with a preferred embodiment of the present invention.

FIG. 3 shows a schematic side view of the preferred digit of the human hand presenting an original secondary feature and other preset secondary features of the preferred digit of the human hand for the method for text input using at least a digit of a human hand of FIG. 1 in accordance with a preferred embodiment of the present invention.

FIG. 4 shows a schematic side view illustrating a virtual character assigning feature lookup table corresponding to the preferred digit of the human hand presenting the original primary feature and the original secondary feature, and presenting the other preset primary features and the other secondary features of the preferred digit of the human hand for the method for text input using at least a digit of a human hand of FIG. 1 in accordance with a preferred embodiment of the present invention.

FIGS. 5a to 5e respectively show schematic side views illustrating the preferred digit of the human hand presenting the original primary feature and each of the other preset primary features of the preferred digit of the human hand, and further depicts where either of the original primary feature and the each of the other preset primary features of the preferred digit of the human hand together with presenting the original secondary feature and the other preset secondary features of the preferred digit of the human hand corresponding to assigned English characters for the method for text input using at least a digit of a human hand of FIG. 1 in accordance with a preferred embodiment of the present invention.

FIGS. 6a to 6e respectively show schematic side views illustrating the preferred digit of the human hand presenting the original primary feature and the each of the other preset primary features of the preferred digit of the human hand, and further depicts where either of the original primary feature and the each of the other preset primary features of the preferred digit of the human hand together with presenting the original secondary feature and the other preset secondary features of the preferred digit of the human hand corresponding to assigned Chinese Zhuyin (Bopomofo) characters for the method for text input using at least a digit of a human hand of FIG. 1 in accordance with a preferred embodiment of the present invention.

FIGS. 7a to 7e, 8a to 8e and 9 respectively show schematic sides views illustrating three preferred digits of the human hand presenting the original primary feature and the each of the other preset primary features of the preferred digit of the human hand, and further depicts where either of the original primary feature and the each of the other preset primary features of the three preferred digits of the human hand together with presenting the original secondary feature and the other preset secondary features of the three preferred digits of the human hand corresponding to assigned Chinese Zhuyin (Bopomofo) characters for the method for text input using at least a digit of a human hand of FIG. 1 in accordance with a preferred embodiment of the present invention.

FIG. 10 shows a schematic flowchart diagram of a method for text input using at least a digit of a human hand in accordance with a second preferred embodiment of the present invention.

FIG. 11 shows a schematic side view combined with FSM (finite state machine) state diagrams illustrating a virtual character assigning feature state diagram corresponding to the preferred digit of the human hand presenting first features to be sensed and second features to be sensed, respectively, for the method for text input using at least a digit of a human hand of FIG. 1 in accordance with the second preferred embodiment of the present invention.

FIGS. 12-13 respectively show schematic sides views combined with FSM (finite state machine) state diagrams illustrating a virtual character assigning feature state diagram corresponding to the preferred digit of the human hand of FIG. 11 correspondingly presenting either first features to be sensed or second features to be sensed separately.

FIG. 14 shows a schematic FSM (finite state machine) state diagram representing a lookup table containing a matrix corresponding to the first features to be sensed and the second features to be sensed for character assigning in accordance with the second preferred embodiment of the present invention.

FIG. 15 shows a schematic FSM (finite state machine) state diagram representing a lookup table in view of the lookup table of FIG. 14 corresponding to assigned English characters for the method for text input using at least a digit of a human hand of FIG. 10 in accordance with the second preferred embodiment of the present invention.

FIG. 16 shows a schematic FSM (finite state machine) state diagram representing a lookup table in view of the lookup table of FIG. 14 corresponding to assigned Chinese Zhuyin (Bopomofo) characters for the method for text input using at least a digit of a human hand of

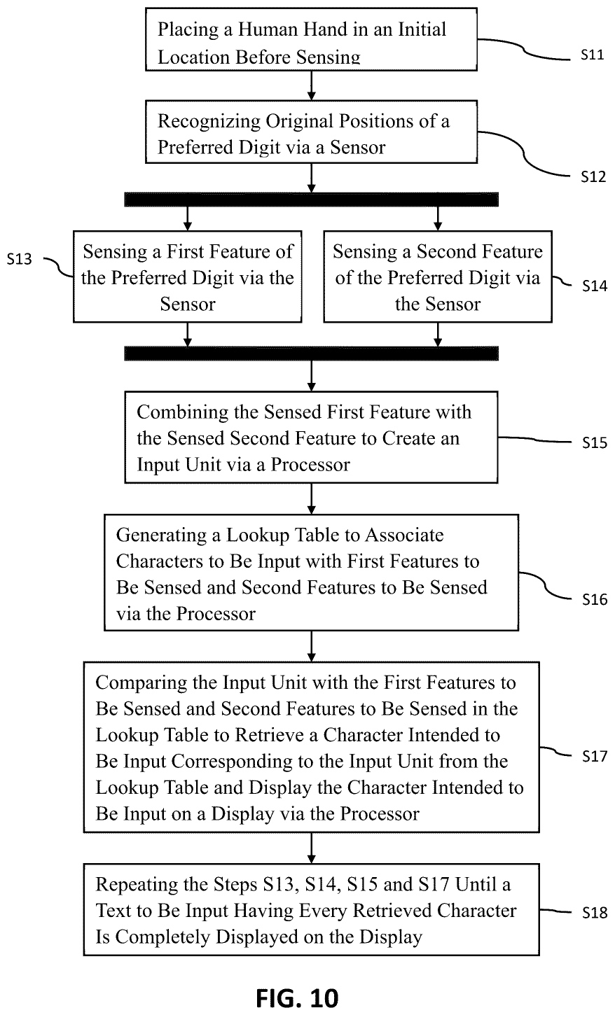

FIG. 10 in accordance with the second preferred embodiment of the present invention.

### DETAILED DESCRIPTION OF THE INVENTION

In order to facilitate best understanding of the present invention, the present invention will be illustrated in more detail below in conjunction with the attached drawings and preferred embodiments. It should be noted that when an element is expressed as “being fixed to” another element, this element may be directly on the another element, or there may be one or more intervening elements between this element and the another element. When an element is expressed as “being connected to” another element, this element can be directly connected to the another element, or there may be one or more intervening elements between this element and the another element. In addition, terminology such as “first”, “second”, etc., is only used for descriptive purposes, and cannot be understood as indicating or implying relative importance.

Unless otherwise defined, any technical and scientific terminology used in this specification has the same meaning as commonly understood by those skilled in the technical field of the present invention. Terminology used in this specification of the present invention is only for a purpose of describing specific embodiments, and is not used to limit the present invention. Terminology such as “and/or” used in this specification includes any and all combinations of one or more related listed items.

In addition, technical features involved in different embodiments of the present invention described below can be mutually combined as long as they do not conflict with one another.

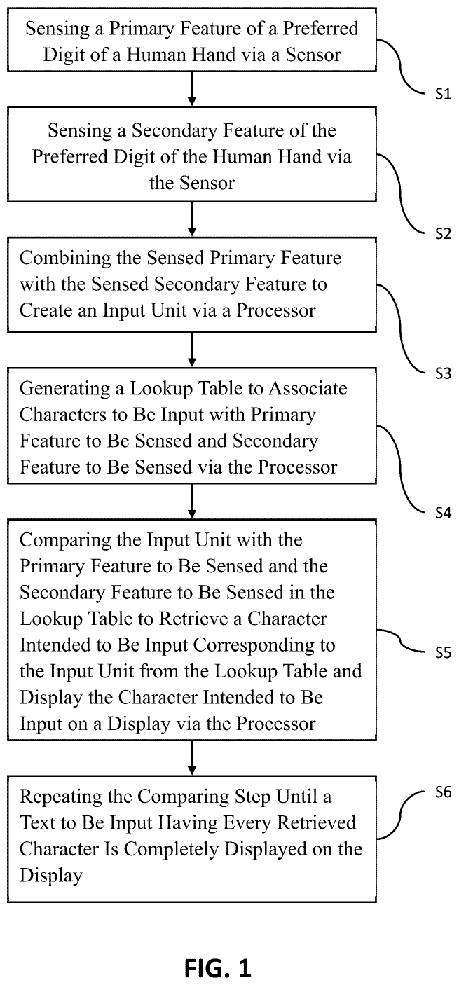

Referring to FIG. 1, a method for text input using at least a digit of a human hand in accordance with a preferred embodiment of the present invention includes the following steps.

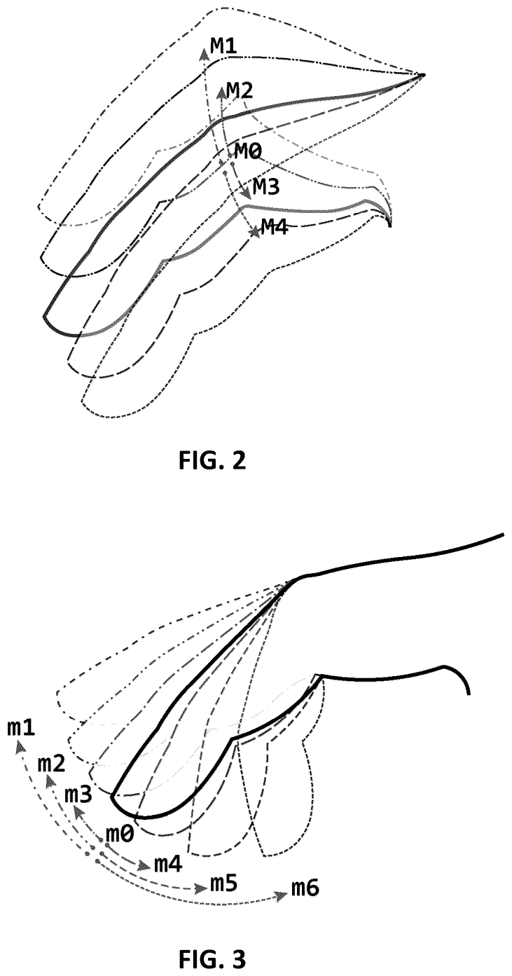

A first step S1 is provided for sensing a primary feature (i.e., primary features M0 to M4 as shown in FIG. 2) of a preferred digit of a human hand via a sensor. The preferred digit of the human hand may be either one of a thumb, an index finger, a middle finger, a ring finger and a little finger. The primary feature M0 in FIG. 2 is defined as an original primary feature of the preferred digit of the human hand. The primary feature M1 in FIG. 2 is defined as a first moving feature of the preferred digit of the human hand away from the original primary feature M0. In the preferred embodiment of the present invention as shown in FIG. 2, the first primary feature M1 is a primary feature of the preferred digit of the human hand moving upwards away from the original primary feature M0. Alternatively, the first primary feature M1 can be a primary feature of the preferred digit of the human hand moving downwards away from the original primary feature M0. In a preferred embodiment of the present invention as shown in FIG. 2, the first primary feature M1 is a primary feature of the preferred digit of the human hand moving away from the original primary feature M0 along a first direction (i.e., an upward direction as shown in FIG. 2) for a first distance. In the preferred embodiment of the present invention, the first distance is defined as a longest distance the preferred digit of the human hand can be moved upwards in FIG. 2 under a preferred comfortable condition of the preferred digit of the human hand. The primary feature M2 in FIG. 2 is defined as a second moving feature of the preferred digit of the human hand away from the original primary feature M0. In the preferred embodiment of the present invention as shown in FIG. 2, the second primary feature M2 is defined as a primary feature of the preferred digit of the human hand moving away from the original primary feature M0 along the first direction for a second distance. Preferably, the second distance is a half of the first distance. The primary feature M3 in FIG. 2 is defined as a third moving feature of the preferred digit of the human hand away from the original primary feature M0 along a second direction. Preferably, the second direction is a direction opposite to the first direction (i.e., a downward direction as shown in FIG. 2). In the preferred embodiment of the present invention as shown in FIG. 2, the third primary feature M3 is defined as a primary feature of the preferred digit of the human hand moving away from the original primary feature M0 along the second direction for a third distance. The primary feature M4 in FIG. 2 is defined as a fourth moving feature of the preferred digit of the human hand away from the original primary feature M0 along the second direction. In the preferred embodiment of the present invention as shown in FIG. 2, the fourth primary feature M4 is defined as a primary feature of the preferred digit of the human hand moving away from the original primary feature M0 along the second direction for a fourth distance. Preferably, the fourth distance is defined as a longest distance the preferred digit of the human hand can be moved downwards in FIG. 2 under a preferred comfortable condition of the preferred digit of the human hand. In the preferred embodiment of the present invention as show in FIG. 2, the fourth distance is twice of the third distance.

A second step S2 is provided for sensing a secondary feature (i.e., secondary features m0 to m6 as shown in FIG. 3) of the preferred digit of the human hand via the sensor. The secondary features are defined as features of at least a distal phalange of the preferred digit of the human hand. In the case of the preferred digit of the human hand being a thumb, the secondary features are defined as distal features of a distal phalange of the thumb. In the case of the preferred digit of the human hand being a digit of the human hand other than the thumb, the secondary features are defined as distal features of a distal phalange and an intermediate phalange of the digit of the human hand other than the thumb. The secondary feature m0 in FIG. 3 is defined as an original secondary feature of the preferred digit of the human hand. The secondary feature m1 in FIG. 3 is defined as a first moving secondary feature of the preferred digit of the human hand away from the original secondary feature m0. In the preferred embodiment of the present invention as shown in FIG. 3, the first secondary feature m1 is a secondary feature of the preferred digit of the human hand moving away from the original secondary feature m0 along the first direction (i.e., the upward direction as shown in FIG. 3) for a fifth distance. In the preferred embodiment of the present invention, the fifth distance is defined as a longest distance a distal phalange of the preferred digit of the human hand can be moved upwards in FIG. 3 under the preferred comfortable condition of the preferred digit of the human hand. The secondary feature m2 in FIG. 3 is defined as a second moving secondary feature of the preferred digit of the human hand away from the original secondary feature m0. In the preferred embodiment of the present invention as shown in FIG. 3, the second secondary feature m2 is a secondary feature of the preferred digit of the human hand moving away from the original secondary feature m0 along the first direction for a sixth distance. The secondary feature m3 in FIG. 3 is defined as a third moving secondary feature of the preferred digit of the human hand away from the original secondary feature m0. In the preferred embodiment of the present invention as shown in FIG. 3, the third secondary feature m3 is a secondary feature of the preferred digit of the human hand moving away from the original secondary feature m0 along the first direction for a seventh distance. In the preferred embodiment of the present invention as show in FIG. 3, the sixth distance is twice of the seventh distance, and the fifth distance is triple of the seventh distance. The secondary feature m4 in FIG. 3 is defined as a fourth moving secondary feature of the preferred digit of the human hand away from the original secondary feature m0. In the preferred embodiment of the present invention as shown in FIG. 3, the fourth secondary feature m4 is a secondary feature of the preferred digit of the human hand moving away from the original secondary feature m0 along the second direction (i.e., the downward direction as shown in FIG. 3) for an eighth distance. The secondary feature m5 in FIG. 3 is defined as a fifth moving secondary feature of the preferred digit of the human hand away from the original secondary feature m0. In the preferred embodiment of the present invention as shown in FIG. 3, the fifth secondary feature m5 is a secondary feature of the preferred digit of the human hand moving away from the original secondary feature m0 along the second direction for a ninth distance. The secondary feature m6 in FIG. 3 is defined as a sixth moving secondary feature of the preferred digit of the human hand away from the original secondary feature m0. In the preferred embodiment of the present invention as shown in FIG. 3, the sixth secondary feature m6 is a secondary feature of the preferred digit of the human hand moving away from the original secondary feature m0 along the second direction for a tenth distance. Preferably, the tenth distance is defined as a longest distance the distal phalange of the preferred digit of the human hand can be moved downwards in FIG. 3 under a preferred comfortable condition of the preferred digit of the human hand. In the preferred embodiment of the present invention as show in FIG. 3, the ninth distance is twice of the eighth distance, and the tenth distance is triple of the eighth distance.

Alternatively, the first step S1 can be performed after the second step S2 or the first step S1 and the second step S2 can be performed simultaneously. In the preferred embodiment of the present invention as shown in FIG. 1, the preferred digit of the human hand is used to perform both of the first step S1 and the second step S2 sequentially. Alternatively, the preferred digit of the human hand can be used to only perform a selective one of the first step S1 and the second step S2 while another preferred digit of the human hand is used to perform the other one of the first step S1 and the second step S2. Of course, in the case that both of the preferred digit of the human hand and the another preferred digit of the human hand are used, the first step S1 and the second step S2 can be performed sequentially or simultaneously.

A third step S3 is provided for combining the sensed primary feature with the sensed secondary feature to create an input unit via a processor signally communicated with the sensor. The input unit can be in form of a matrix, or other proper forms to record the sensed primary feature and the sensed secondary feature. In the preferred embodiment of the present invention as shown in FIG. 2, the sensed primary feature is recorded as a sensed one of “M0, . . . , M4” which respectively represent the original and first to fourth primary features as shown in FIG. 2. In the preferred embodiment of the present invention as shown in FIG. 3, the sensed secondary feature is recorded as a sensed one of “m0, . . . , m6” which respectively represent the original and first to sixth secondary features as shown in FIG. 3. For instance, in the preferred embodiment of the present invention as shown in FIG. 2 and FIG. 3, the input unit is combined and recorded as “[M2, m3]” when the preferred digit of the human hand is sensed to sequentially move to the second primary feature M2 in the first step S1 and move to the third secondary feature m3 in the second step S2.

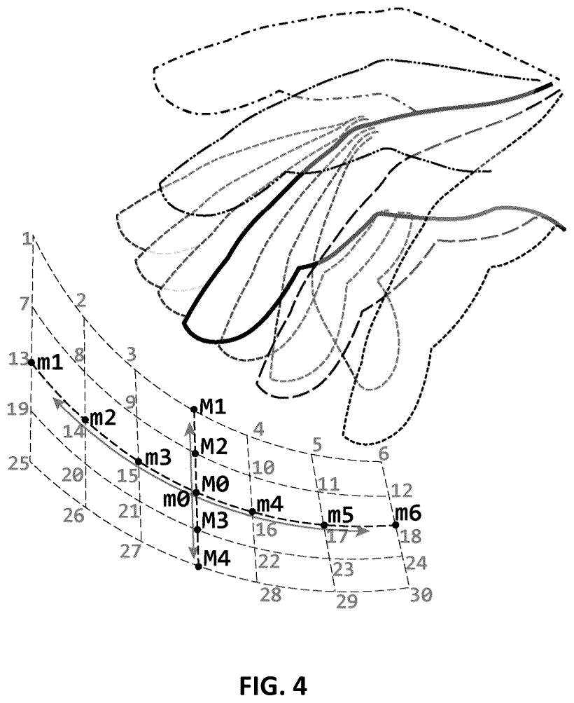

A fourth step S4 is provided for generating a lookup table (i.e., a virtual character assigning feature lookup table containing character assigning features 1-30 as shown in FIG. 4) to associate characters to be input with primary features to be sensed and secondary features to be sensed via the processor. The generated lookup table is configurated to be saved in a memory signally communicated with the processor. In the preferred embodiment of the present invention as shown in FIG. 4, the lookup table is configurated to expand by using the primary features to be sensed (i.e., the primary features M0 to M4 as shown in FIG. 2) as vertical coordinates and the secondary features to be sensed (i.e., the secondary features m0 to m6 as shown in FIG. 3) as horizontal coordinates. In the preferred embodiment of the present invention as shown in FIG. 4, the lookup table is a 5 by 6 matrix with the character assigning features 1-30 as shown in FIG. 4. Taking text input in English as an example, either one of English characters A-Z can be respectively exclusively assigned to a selective one of the character assigning features 1-30 as shown in FIG. 4.

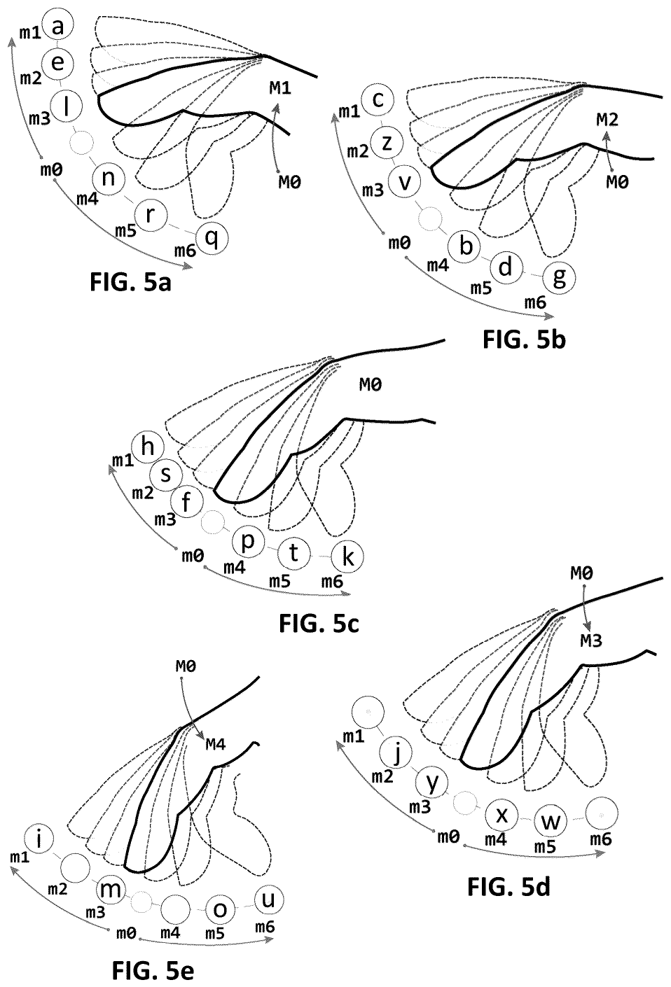

Further referring to FIG. 4 and FIGS. 5a to 5e together, the character assigning features 1-6 of the lookup table as shown in FIG. 4 are respectively used and assigned for English characters “a”, “e”, “l”, “n”, “r” and “q” as shown in FIG. 5a. The character assigning features 7-12 of the lookup table as shown in FIG. 4 are respectively used and assigned for English characters “c”, “z”, “v”, “b”, “d” and “g” as shown in FIG. 5b. The character assigning features 13-18 of the lookup table as shown in FIG. 4 are respectively used and assigned for English characters “h”, “s”, “f”, “p”, “t” and “k” as shown in FIG. 5c. The character assigning features 20-23 of the lookup table as shown in FIG. 4 are respectively used and assigned for English characters “j”, “y”, “x” and “w” as shown in FIG. 5d while the character assigning features 19 and 24 of the lookup table as shown in FIG. 4 are left to be unassigned. The character assigning features 25, 27 and 29-30 of the lookup table as shown in FIG. 4 are respectively used and assigned for English characters “i”, “m”, “o” and “u” as shown in FIG. 5e while the character assigning features 26 and 28 of the lookup table as shown in FIG. 4 are left to be unassigned. Of course, the English characters can be assigned in other ways different from the assigning way as shown in FIGS. 5a to 5e as long as all of English characters are respectively and exclusively assigned to corresponding character assigning features selected from the character assigning features 1-30 of the lookup table as shown in FIG. 4.

Alternatively, the fourth step S4 can be performed before the first step S1 or the fourth step S4 and the first step S1 to the third step S3 can be performed simultaneously. In the preferred embodiment of the present invention as shown in FIG. 1, the fourth step S4 is performed after the third step S3 so as to provide a comparative source together with the third step before following steps of the present invention.

A fifth step S5 is provided for comparing the input unit with the primary features to be sensed and the secondary features to be sensed in the lookup table to retrieve a character intended to be input corresponding to the input unit from the lookup table and display the character intended to be input on a display via the processor. The display is signally communicated with the processor so that the processor can control display contents of the display. Referring to FIGS. 5a to 5e, taking text input in English as an example, English characters A-Z are respectively assigned in the lookup table as shown in FIGS. 5a to 5e. The English characters are preferably assigned in the lookup table based on preset conditions, for example, frequent use of particular English characters, comfortable movement of the preferred digit of the human hand, etc. Using the lookup table as showing in FIGS. 5a to 5e, when a text to be input, “text” as an example, is intended to be input, a first input unit of “[M0, m5]” for the text to be input is combined to be created by the processor in the third step S3 after the original primary feature “M0” is sensed by the sensor in the first step S1 and the fifth secondary feature “m5” is sensed by the sensor in the second step S2. The first input unit of “[M0, m5]” for the text to be input is subsequently used to be compared in the fifth step S5 with the lookup table generated in the fourth step S4 in order to retrieve the first English character “t” of the text to be input, “text”, and display the retrieved first English character “t” on the display since, according to the lookup table as shown in FIG. 4 and FIG. 5c, the character assigning feature 17 of the lookup table as shown in FIG. 4 is assigned to the English character “t” as shown in FIG. 5c corresponding to the first input unit of “[M0, m5]”.

A sixth step S6 is provided for repeating the first step S1, the second step S2, the third step S3 and the fifth step S5, i.e., the sensing primary feature step, the sensing secondary feature step, the combining step and the comparing step as shown in FIG. 1, until a text to be input having every retrieved character is completely displayed on the display. As stated above and taking the above text, “text”, intended to be input as an example, after the first English character “t” is displayed on the display by performing the first step S1, the second step S2, the third step S3 and the fifth step S5 in sequence, the second English character “e” of the text to be input, “text”, is retrieved and displayed on the display in a repeated fifth step S5 after the first primary feature “M1” and the second secondary feature “m2” are respectively sensed in repeated first and second steps S1, S2, and a second input unit of “[M1, m2]” is combined to be created in a repeated third step S3. The first step S1, the second step S2, the third step S3 and the fifth step S5 are subsequently repeated for two more times in order to respectively retrieve and display the rest English characters, “x” and “t”, of the text to be input, “text”. The sixth step S6 is completed when all English characters, “t”, “e”, “x” and “t”, of the text to be input, “text”, are entirely displayed on the display. The method for text input using at least a digit of a human hand in accordance with the preferred embodiment of the present invention will be started over again when a next text to be input is ready to be input.

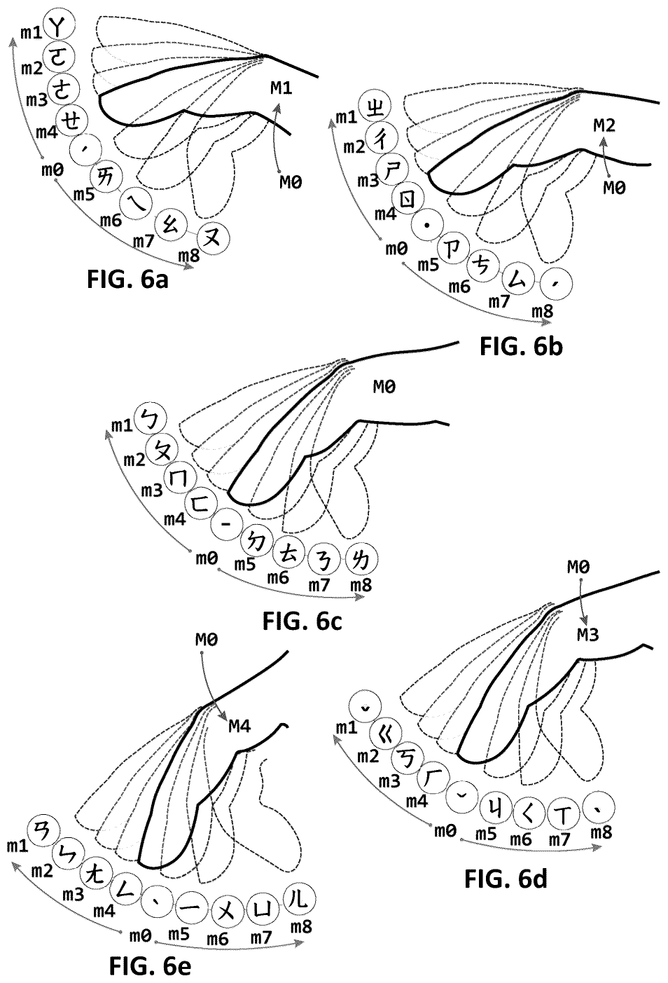

Referring to FIGS. 6a to 6e, a lookup table for a Chinese text to be input by using a single digit of the human hand in accordance with a preferred embodiment of the present invention is shown. As shown in FIGS. 6a to 6e, the lookup table is a 5 by 9 matrix with 45 character assigning features as shown in FIGS. 6a to 6e as a whole. 37 Zhuyin (Bopomofo) characters and 5 tone marks required for inputting a Chinese word included in the Chinese text to be input are respectively and exclusively assigned to selective ones of the 45 character assigning features as shown in FIGS. 6a to 6e. Taking the Chinese word “ [symbol] ” as an example, Zhuyin characters “ [symbol] ”, “ [symbol] ”, “ [symbol] ” and a first tone mark “” are required to be input in order for displaying the Chinese word “ [symbol] ” on the display. Hence, at least a first input unit “[M2, m1]” for the Zhuyin character “ [symbol] ”, a second input unit “[M4, m6]” for the Zhuyin character “ [symbol] ”, and a third input unit “[M4, m4]” for the Zhuyin character “ [symbol] ” are respectively retrieved and temporarily displayed on the display, and a fourth input unit “[M0, m0]” for the first tone mark is retrieved only to further trigger display of the Chinese word “ [symbol] ” on the display by performing the sixth step S6 repeatedly for at least four times. After the required first tone mark is retrieved, the Chinese word “ [symbol] ” corresponding to the Zhuyin characters “ [symbol] ”, “ [symbol] ”, “ [symbol] ” and the first tone mark is automatically generated and displayed on the display via the processor while the temporarily displayed Zhuyin characters “ [symbol] ”, “ [symbol] ”, “ [symbol] ” are removed from the display via the processor.

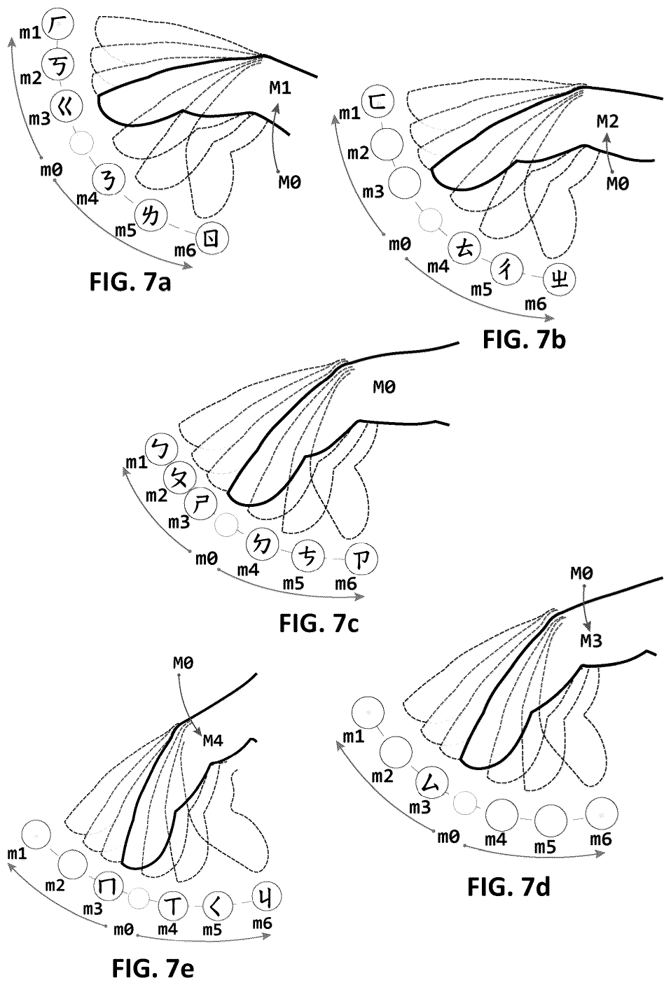

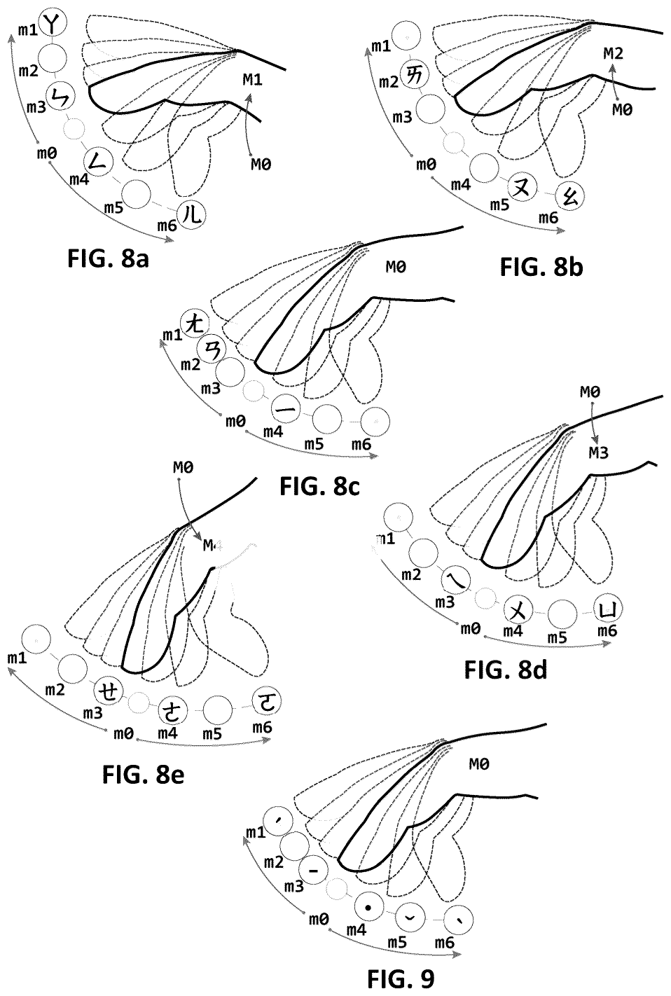

Referring to FIGS. 7a to 7e, 8a to 8e and 9, three lookup tables for a Chinese text to be input by respectively using three different preferred digits of the human hand in accordance with a preferred embodiment of the present invention are shown. FIGS. 7a to 7e show the original primary feature M0 and the first to fourth primary features M1 to M4, and the original secondary feature m0 and the first to sixth secondary features m1 to m6 of a first preferred digit of the human hand, and associated Chinese Zhuyin characters in accordance with a preferred embodiment of the present invention. FIGS. 8a to 8e show the original primary feature M0 and the first to fourth primary features M1 to M4, and the original secondary feature m0 and the first to sixth secondary features m1 to m6 of a second preferred digit of the human hand, and associated Chinese Zhuyin characters in accordance with a preferred embodiment of the present invention. FIG. 9 shows the original primary feature M0 and the original secondary feature m0 and the first to sixth secondary features m1 to m6 of a third preferred digit of the human hand, and associated tone marks in accordance with a preferred embodiment of the present invention. In the preferred embodiment of the present invention, the Chinese text to be input is input by using the three different preferred digits of the human hand simultaneously or sequentially, and movements of all of the three different preferred digits of the human hand are respectively sensed by the sensor to generate at least three input units in order to input the Chinese text to be input. Taking the Chinese word “ [symbol] ” as an example again, the Zhuyin character “ [symbol] ” as shown in FIG. 7b is displayed on the display by sensing movement of the first preferred digit of the human hand and being retrieved from the lookup table as shown in FIGS. 7a to 7e based on the combined input unit “M2, m6”. The Zhuyin characters “ [symbol] ”, “ [symbol] ” respectively as shown in FIGS. 8d and 8a are sequentially displayed on the display by sensing movements of the second preferred digit of the human hand and being retrieved from the lookup table as shown in FIGS. 8a to 8e based on the combined input units “M3, m4” and “M1, m4” sequentially. The first tone mark “-” as shown in FIG. 9 is retrieved from the lookup table as shown in FIG. 9 based on the combined input unit “M0, m3” after sensing movement of the third preferred digit of the human hand and then further triggering display of the Chinese word “ [symbol] ” on the display.

Further referring to FIG. 10, a method for text input using at least a digit of a human hand in accordance with a second preferred embodiment of the present invention is illustrated. In the second preferred embodiment, the human hand to be sensed in a preset initial location is firstly sensed and recognized by at least a sensor. In the present initial location of the human hand, an original position of each of the at least a digit of the human hand is simultaneously sensed, recognized and recorded via the sensor. The method includes the following steps.

A first step S11 is provided for placing a human hand in an initial location before sensing. In the initial location of the human hand before sensing, each digit of the human hand is relaxed and naturally placed without any external stress or force applied thereon.

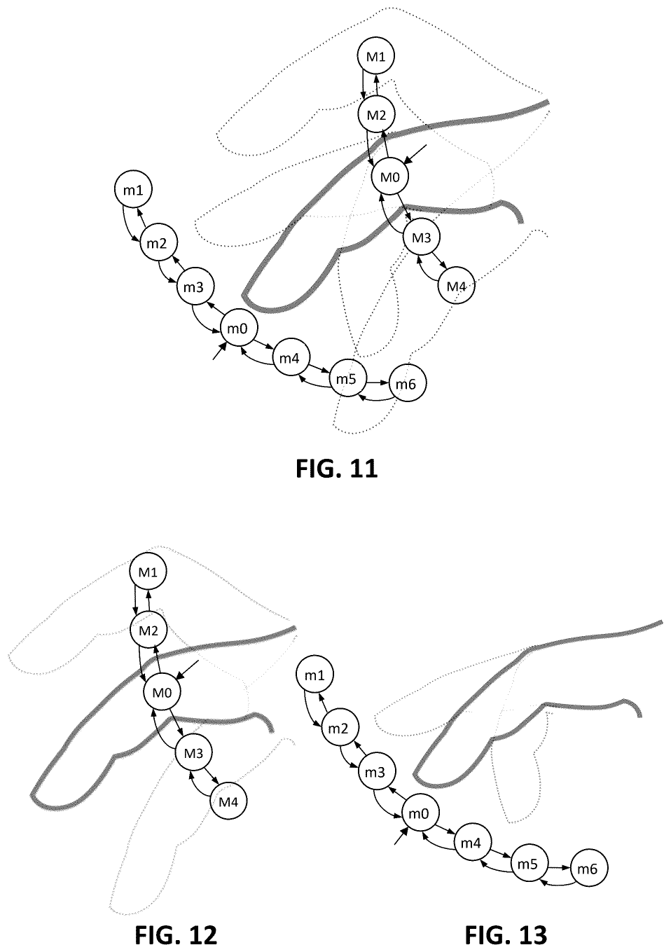

A second step S12 is provided for recognizing original positions of a preferred digit of the human hand via a sensor. In the second preferred embodiment, the original positions of the preferred digit include at least two sub-original positions. A first original position M0 (As shown in FIGS. 11-12 and 14-16) of the preferred digit is sensed and recognized as an original position of a first part of the preferred digit of the human hand. A second original position m0 (As shown in FIGS. 11 and 13-16) is sensed and recognized as an original position of a second part of the preferred digit of the human hand from a fingertip of the preferred digit to a preset knuckle of the preferred digit. In the second preferred embodiment, the first original position M0 is recognized as an original position of a proximal phalange of the preferred digit of the human hand. The second original position m0 is recognized as an original position of a distal phalange and an intermediate phalange of the preferred digit of the human hand.

A third step S13 is provided for sensing a first feature (i.e., first features marked as original and moving positions M0 to M4 as shown in FIGS. 11-12) of a preferred digit of a human hand via the sensor. In the second preferred embodiment, the first feature to be sensed includes the first original position M0 as depicted above, a first moving position M1, a second moving position M2, a third moving position M3 and a fourth moving position M4, and each of the first to fourth moving position M1 to M4 is recognized by exclusively moving the first part of the preferred digit of the human hand without moving other parts of the human hand, such as a palm of the human hand. Alternatively, the each of the first to fourth moving position M1 to M4 is recognized as a relative movement of the first part of the preferred digit of the human hand to other parts of the human hand, such as the palm of the human hand. The first moving position M1 in FIG. 11 is defined as a first feature of the first part of the preferred digit of the human hand moving away from the first original position M0. In the second preferred embodiment of the present invention as shown in FIG. 11, the first moving position M1 is a first feature of the preferred digit of the human hand moving upwards away from the first original position M0. Alternatively, the first moving position M1 can be a first feature of the preferred digit of the human hand moving downwards away from the first original position M0. In the second preferred embodiment of the present invention as shown in FIG. 11, the first moving position M1 is a first feature of the preferred digit of the human hand moving away from the first original position M0 along a first direction (i.e., an upward direction as shown in FIG. 11) for a first distance. In the second preferred embodiment of the present invention, the first distance is defined as a longest distance the preferred digit of the human hand can be moved upwards in FIG. 11 under a preferred comfortable condition of the preferred digit of the human hand. The second moving position M2 in FIG. 11 is defined as a first feature of the first part of the preferred digit of the human hand moving away from the first original position M0 along the first direction. In the second preferred embodiment of the present invention as shown in FIG. 11, the second moving position M2 is defined as a first feature of the preferred digit of the human hand moving away from the first original position M0 along the first direction for a second distance. Preferably, the second distance is a half of the first distance. The third moving position M3 in FIG. 11 is defined as a first feature of the first part of the preferred digit of the human hand moving away from the first original position M0 along a second direction. Preferably, the second direction is a direction opposite to the first direction (i.e., a downward direction as shown in FIG. 11). In the second preferred embodiment of the present invention as shown in FIG. 11, the third moving position M3 is defined as a first feature of the preferred digit of the human hand moving away from the first original position M0 along the second direction for a third distance. The fourth moving position M4 in FIG. 11 is defined as a first feature of the first part of the preferred digit of the human hand moving away from the first original position M0 along the second direction. In the second preferred embodiment of the present invention as shown in FIG. 11, the fourth moving position M4 is defined as a first feature of the preferred digit of the human hand moving away from the first original position M0 along the second direction for a fourth distance. Preferably, the fourth distance is defined as a longest distance the preferred digit of the human hand can be moved downwards in FIG. 11 under a preferred comfortable condition of the preferred digit of the human hand. In the preferred embodiment of the present invention as shown in FIG. 11, the fourth distance is twice of the third distance. When the first part of the preferred digit of the human hand does not move at all, a sensed result of the third step S13 is the first original position M0. When the first part of the preferred digit of the human hand moves upwards, a sensed result of the third step S13 can be either the first moving position M1 or the second moving position M2. When the first part of the preferred digit of the human hand moves downwards, a sensed result of the third step S13 can be either the third moving position M3 or the fourth moving position M4.

A fourth step S14 is provided for sensing a second feature (i.e., second features marked as original and moving positions m0 to m6 as shown in FIGS. 11 and 13) of the preferred digit of the human hand via the sensor. In the second preferred embodiment, the second feature to be sensed includes the second original position m0 as depicted above, a first moving position m1, a second moving position m2, a third moving position m3, a fourth moving position m4, a fifth moving position m4 and a sixth moving position m6. The first moving position m1 in FIG. 11 is defined as a second feature of the second part of the preferred digit of the human hand moving away from the second original position m. In the second preferred embodiment of the present invention as shown in FIG. 11, the first moving position m1 is a second feature of the preferred digit of the human hand moving away from the second original position m0 along the first direction (i.e., the upward direction as shown in FIG. 11) for a fifth distance. In the second preferred embodiment of the present invention, the fifth distance is defined as a longest distance the second part of the preferred digit of the human hand can be moved upwards in FIG. 11 under the preferred comfortable condition of the preferred digit of the human hand. The second moving position m2 in FIG. 11 is defined as a second feature of the second part of the preferred digit of the human hand moving away from the second original position m0. In the second preferred embodiment of the present invention as shown in FIG. 11, the second moving position m2 is a second feature of the preferred digit of the human hand moving away from the second original position m0 along the first direction for a sixth distance. The third moving position m3 in FIG. 11 is defined as a second feature of the second part of the preferred digit of the human hand moving away from the second original position m0. In the second preferred embodiment of the present invention as shown in FIG. 11, the third moving position m3 is a second feature of the preferred digit of the human hand moving away from the second original position m0 along the first direction for a seventh distance. In the second preferred embodiment of the present invention as show in FIG. 11, the sixth distance is twice of the seventh distance, and the fifth distance is triple of the seventh distance. The fourth moving position m4 in FIG. 11 is defined as a second feature of the second part of the preferred digit of the human hand moving away from the second original position m0. In the second preferred embodiment of the present invention as shown in FIG. 11, the fourth moving position m4 is a second feature of the preferred digit of the human hand moving away from the second original position m0 along the second direction (i.e., the downward direction as shown in FIG. 11) for an eighth distance. The fifth moving position m5 in FIG. 11 is defined as a second feature of the second part of the preferred digit of the human hand moving away from the second original position m0. In the second preferred embodiment of the present invention as shown in FIG. 11, the fifth moving position m5 is a second feature of the preferred digit of the human hand moving away from the second original position m0 along the second direction for a ninth distance. The sixth moving position m6 in FIG. 11 is defined as a second feature of the second part of the preferred digit of the human hand moving away from the second original position m0. In the second preferred embodiment of the present invention as shown in FIG. 11, the sixth moving position m6 is a second feature of the preferred digit of the human hand moving away from the second original position m0 along the second direction for a tenth distance. Preferably, the tenth distance is defined as a longest distance the second part of the preferred digit of the human hand can be moved downwards in FIG. 11 under a preferred comfortable condition of the preferred digit of the human hand. In the second preferred embodiment of the present invention as show in FIG. 11, the ninth distance is twice of the eighth distance, and the tenth distance is triple of the eighth distance.

In the second preferred embodiment of the present invention as shown in FIG. 10, the third step S13 and the fourth step S14 are performed simultaneously. Alternatively, the third step S13 and the fourth step S14 can be performed sequentially by performing the fourth step S14 after the third step S13 or the third step S13 after the fourth step S14. Alternatively, the preferred digit of the human hand can be used to only perform a selective one of the third step S13 and the fourth step S14 while another preferred digit of the human hand is used to perform the other one of the third step S13 and the fourth step S14. Of course, in the case that both of the preferred digit of the human hand and the another preferred digit of the human hand are used, the third step S13 and the fourth step S14 can be performed sequentially or simultaneously. In conclusion, the third step S13 and the fourth step S14 are executed completely before proceeding to any next step following the third step S13 and the fourth step S14.

A fifth step S15 is provided for combining the sensed first feature with the sensed second feature to create an input unit via a processor signally communicated with the sensor. The input unit can be in form of a matrix, or other proper forms to record the sensed first feature and the sensed second feature. In the second preferred embodiment of the present invention as shown in FIG. 11, the sensed first feature is recorded as a sensed one of “M0, . . . , M4” which respectively represent the first original position M0 and the first to fourth moving positions M1 to M4 as shown in FIG. 11. The sensed second feature is recorded as a sensed one of “m0, . . . , m6” which respectively represent the second original position m0 and the first to sixth moving positions m1 to m6 as shown in FIG. 11. For instance, in the second preferred embodiment of the present invention as shown in FIG. 11, the input unit is combined and recorded as “[M2, m3]” when the first part of the preferred digit of the human hand is sensed to sequentially move to the second moving position M2 in the third step S13, and the second part of the preferred digit of the human hand is sensed to sequentially move to the third moving position m3 in the fourth step S14. As state above, the third step S13 and the fourth step S14 are executed completely before proceeding to the fifth step S15 following the third step S13 and the fourth step S14.

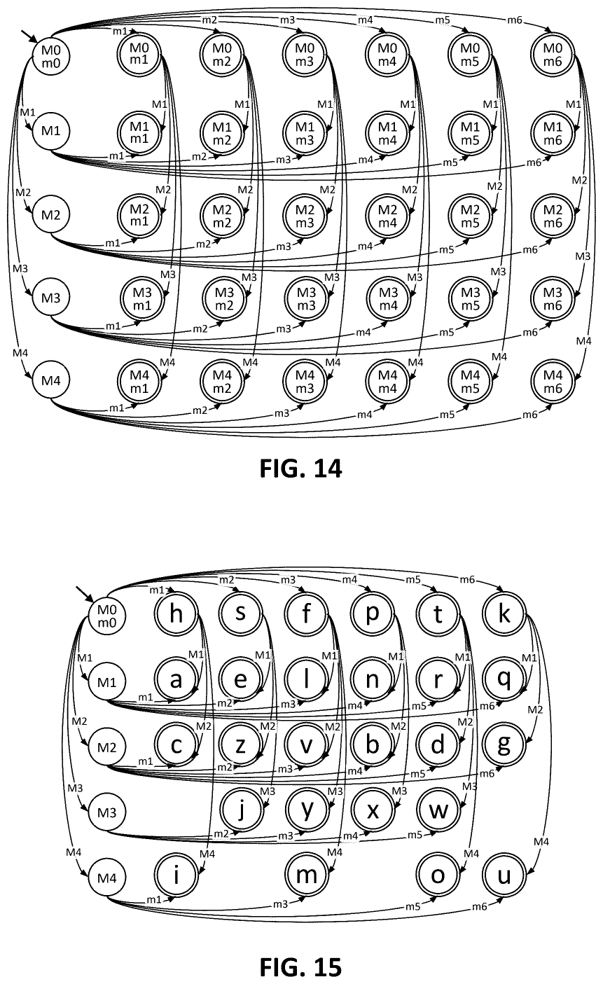

A sixth step S16 is provided for generating a lookup table (i.e., a virtual character assigning feature state diagram containing character assigning features as shown in FIG. 14) to associate characters to be input with first features to be sensed and second features to be sensed via the processor. The generated lookup table is configurated to be saved in a memory signally communicated with the processor. In the second preferred embodiment of the present invention as shown in FIG. 14, the lookup table is configurated to expand by using the first features to be sensed (i.e., the first original position M0 and the moving positions M1 to M4 as shown in FIG. 11) as vertical coordinates and the second features to be sensed (i.e., the second original position m0 and the moving positions m1 to m6 as shown in FIG. 11) as horizontal coordinates. In the second preferred embodiment of the present invention as shown in FIG. 14, the lookup table is a 5 by 7 matrix with the character assigning features as shown in FIG. 14. Taking text input in English as an example, either one of English characters A-Z can be respectively exclusively assigned to a selective one of the character assigning features as shown in FIG. 14.

In the second preferred embodiment of the present invention as shown in FIG. 10, the sixth step S16 is sequentially performed after the third step S13 and the fourth step S14. Alternatively, the sixth step S16 can be performed sequentially before the third step S13 and the fourth step S14, or be performed together with the third step S13 and the fourth step S14 simultaneously.

A seventh step S17 is provided for comparing the input unit with the first features to be sensed and the second features to be sensed in the lookup table to retrieve a character intended to be input corresponding to the input unit from the lookup table and display the character intended to be input on a display via the processor. The display is signally communicated with the processor so that the processor can control display contents of the display. Referring to FIG. 15, taking text input in English as an example, English characters A-Z are respectively assigned in the lookup table as shown in FIG. 15. The English characters are preferably assigned in the lookup table based on preset conditions, for example, frequent use of particular English characters, comfortable movement of the preferred digit of the human hand, etc. Using the lookup table as showing in FIG. 15, when a text to be input, “text” as an example, is intended to be input, a first input unit of “[M0, m5]” for the text to be input is combined to be created by the processor in the fifth step S15 after the first original position “M0” is sensed by the sensor in the third step S13 and the fifth moving position “m5” is sensed by the sensor in the fourth step S14. The first input unit of “[M0, m5]” for the text to be input is subsequently used to be compared in the seventh step S17 with the lookup table generated in the sixth step S16 in order to retrieve the first English character “t” of the text to be input, “text”, and display the retrieved first English character “t” on the display since, according to the lookup table as shown in FIG. 15, the character assigning feature of the lookup table as shown in FIG. 15 is assigned to the English character “t” as shown in FIG. 15 corresponding to the first input unit of “[M0, m5]”.

An eighth step S18 is provided for repeating the third step S13, the fourth step S14, the fifth step S15 and the seventh step S17, i.e., the sensing first feature step, the sensing second feature step, the combining step and the comparing step as shown in FIG. 10, until a text to be input having every retrieved character is completely displayed on the display. As stated above and taking the above text, “text”, intended to be input as an example, after the first English character “t” is displayed on the display by performing the third step S13, the fourth step S14, the fifth step S15 and the seventh step S17 in sequence, the second English character “e” of the text to be input, “text”, is retrieved and displayed on the display in a repeated seventh step S17 after the first feature “M1” and the second feature “m2” are respectively sensed in repeated third and fourth steps S13, S14, and a second input unit of “[M1, m2]” is combined to be created in a repeated fifth step S15. The third step S13, the fourth step S14, the fifth step S15 and the seventh step S17 are subsequently repeated for two more times in order to respectively retrieve and display the rest English characters, “x” and “t”, of the text to be input, “text”. The eighth step S18 is completed when all English characters, “t”, “e”, “x” and “t”, of the text to be input, “text”, are entirely displayed on the display. The method for text input using at least a digit of a human hand in accordance with the preferred embodiment of the present invention will be started over again when a next text to be input is ready to be input.

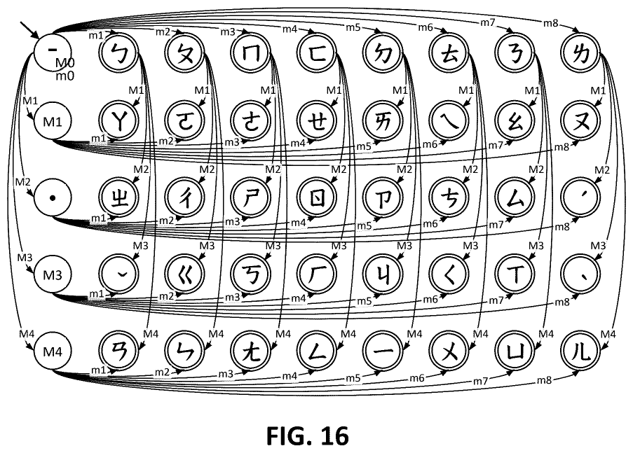

FIG. 16 shows a lookup table for a Chinese text to be input by using the preferred digit of the human hand in accordance with the second preferred embodiment of the present invention. As shown in FIG. 16, the lookup table is a 5 by 9 matrix with 45 character assigning features as shown in FIG. 16. 37 Zhuyin (Bopomofo) characters and 5 tone marks required for inputting a Chinese word included in the Chinese text to be input are respectively and exclusively assigned to selective ones of the 45 character assigning features as shown in FIG. 16. Taking the Chinese word “ [symbol] ” as an example, Zhuyin characters “ [symbol] ”, “ [symbol] ”, “ [symbol] ” and a first tone mark “-” are required to be input in order for displaying the Chinese word “ [symbol] ” on the display. Hence, at least a first input unit “[M2, m1]” for the Zhuyin character “ [symbol] ”, a second input unit “[M4, m6]” for the Zhuyin character “ [symbol] ”, and a third input unit “[M4, m4]” for the Zhuyin character “ [symbol] ” are respectively retrieved and temporarily displayed on the display, and a fourth input unit “[M0, m0]” for the first tone mark is retrieved only to further trigger display of the Chinese word “ [symbol] ” on the display by performing the eighth step S18 repeatedly for at least four times. After the required first tone mark is retrieved, the Chinese word “ [symbol] ” corresponding to the Zhuyin characters “ [symbol] ”, “ [symbol] ”, “ [symbol] ” and the first tone mark is automatically generated and displayed on the display via the processor while the temporarily displayed Zhuyin characters “ [symbol] ”, “ [symbol] ”, “ [symbol] ” are removed from the display via the processor.

Although only the preferred embodiments of the present invention are described as above, the practicing claim scope of the present invention is not limited to the disclosed embodiments. It is understood that any simple equivalent changes, adjustments or modifications to the present invention based on the following claims of the present invention and the content of the above invention description may be still covered within the claimed scope of the following claims of the present invention.

What is claimed is:

1. A method for text input using a preset digit of a human hand, comprising:
placing the human hand in an initial location before sensing;
recognizing a first original position and a second original position of the preset digit of the human hand via a sensor, wherein the first original position is sensed and recognized via sensing a first part of the preset digit of the human hand, and the second original position is sensed and recognized via sensing a second part of the preset digit of the human hand, the first part of the preset digit is different from the second part of the present digit;
sensing a first feature via sensing the first part of the preset digit of the human hand by the sensor, wherein the first feature comprises the first original position and at least one moving position of the first feature;
sensing a second feature via sensing the second part of the preset digit of the human hand by the sensor, wherein the second feature comprises the second original position and at least one moving position of the second feature;
combining the sensed first feature with the sensed second feature to create an input unit via a processor signally communicated with the sensor;
associating characters to be input with first features to be sensed and second features to be sensed via the processor;
comparing the input unit with the first features to be sensed and the second features to be sensed associated with the characters to be input to retrieve a character intended to be input corresponding to the input unit from the associated characters to be input via the processor; and
repeating the sensing first feature step, the sensing second feature step, the combining step and the comparing step until a text to be input having the retrieved character intended to be input is completely input.

2. The method as claimed in claim 1, wherein the associating character step further comprises a step of generating a lookup table to associate the characters to be input with the first features to be sensed and the second features to be sensed for use of lookup in comparison with the input unit.

3. The method as claimed in claim 1, wherein another preset digit of the human hand is used, the text to be input is input via using both of the preset digit and the another preset digit.

4. The method as claimed in claim 1, wherein the at least one moving position of the first feature is defined via moving away from the first original position along a first direction.

5. The method as claimed in claim 4, wherein the at least one moving position of the first feature is defined via moving away from the first original position along either the first direction or a second direction different from the first direction.

6. The method as claimed in claim 5, wherein the second direction is opposite to the first direction.

7. The method as claimed in claim 4, wherein the at least one moving position of the first feature comprises at least two moving positions of the first feature moving away from the first original position along the first direction, and each of the at least two moving positions of the first feature is spaced equidistantly from a neighboring one of the first original position and the at least two moving positions of the first feature next to the each of the at least two moving positions of the first feature.

8. The method as claimed in claim 1, wherein the at least one moving position of the second feature is defined via moving away from the second original position along a first direction.

9. The method as claimed in claim 8, wherein the at least one moving position of the second feature is defined via moving away from the second original position along either the first direction or a second direction different from the first direction.

10. The method as claimed in claim 9, wherein the second direction is opposite to the first direction.

11. The method as claimed in claim 8, wherein the at least one moving position of the second feature comprises at least two moving positions of the second feature moving away from the second original position along the first direction, and each of the at least two moving positions of the second feature is spaced equidistantly from a neighboring one of the second original position and the at least two moving positions of the second feature next to the each of the at least two moving positions of the second feature.

12. The method as claimed in claim 1, wherein the associating step is executed before the sensing first feature step and the sensing second feature step.

13. The method as claimed in claim 1, wherein the sensing first feature step and the sensing second feature step are executed simultaneously.

14. The method as claimed in claim 1, wherein the first part of the preset digit of the human hand is defined as a proximal phalange of the preset digit of the human hand.

15. The method as claimed in claim 1, wherein the second part of the preset of the human hand is defined as a distal phalange and an intermediate phalange of the preset digit of the human hand.

16. A method for text input using at least two preset digits of a human hand, comprising:
placing the human hand in an initial location before sensing;
recognizing a first original position and a second original position of each of the at least two preset digits of the human hand via a sensor, wherein the first original position is sensed and recognized via sensing a first part of the each of the at least two preset digits of the human hand, and the second original position is sensed and recognized via sensing a second part of the each of the at least two preset digits of the human hand, the first part of the each of the at least two preset digits is different from the second part of the each of the at least two present digits;
sensing a first feature via sensing the first part of the each of the at least two preset digits of the human hand by the sensor, wherein the first feature comprises the first original position and at least one moving position of the first feature;
sensing a second feature via sensing the second part of the each of the at least two preset digits of the human hand by the sensor, wherein the second feature comprises the second original position and at least one moving position of the second feature;
combining the sensed first features of the at least two preset digits with the sensed second features of the at least two preset digits to respectively create at least two input units via a processor signally communicated with the sensor;
associating characters to be input with first features to be sensed and second features to be sensed of the each of the at least two preset digits via the processor;
comparing the at least two input units with the first features to be sensed and the second features to be sensed of the each of the at least two preset digits associated with the characters to be input to retrieve at least two characters intended to be input respectively corresponding to the at least two input units from the associated characters to be input via the processor; and
repeating the sensing first feature step, the sensing second feature step, the combining step and the comparing step until a text to be input having the retrieved at least two characters intended to be input is completely input.
